(19) United States
(12) Patent Application Publication
(10) Pub. No.: US 2005/0038832 A1
(43) Pub. Date: Feb. 17, 2005

(54) Application error recovery using solution database

(75) Inventor: Lee Feigenbaum, Brookline, MA (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/640,979

(22) Filed: Aug. 14, 2003

(51) Int. Cl. G06F 12/00

(52) U.S. Cl. 707/202

(57) ABSTRACT

A system, method and computer readable medium for performing error recovery for an application is disclosed. The method on a computer includes capturing an error in the execution of the application, wherein information is associated with the error and generating an identifier for the error based on the information associated with the error. The method further includes generating a message for a third party, the message including the identifier, and sending the message to the third party. The method further includes receiving the solution from the third party and applying the solution to the application so as to cure the error, if the third party finds a solution to the error based on the identifier.

### BACKGROUND OF THE INVENTION

1. Field of the Invention

This invention generally relates to the field of application error recovery and more specifically to automatic application error recovery using a bug-fix database.

2. Description of Related Art

Client-side applications fall into two general categories. The first category includes traditional applications that are written in programming languages, such as C or C++, and are compiled directly to machine code. These applications are run via the machine's processor directly executing the machine code. In these native code client applications, application-level runtime errors will (in the absence of explicit checking by the application itself) manifest themselves as hardware traps (segmentation faults, access violations, and more.). The information that characterizes such an error is often inconsistent (e.g., different memory addresses) and unpredictable, since errors involving an invalid pointer may manifest themselves in seemingly random execution contexts after the actual error. Associated error information can also be difficult to gather, typically requiring either an application-specific exception-catching mechanism or a system-wide debugging application.

The second category of application relies on some degree of runtime that sits between the application and the machine and manages the execution of the application. Such “managed runtimes” run the gauntlet from Java virtual machines and Microsoft's Common Language Runtime (CLR) to higher level, interpreted scripting environments such as JavaScript, Perl, and Python. A checked runtime system (e.g., a scripting language), on the other hand, is designed to catch application-level errors to prevent abnormal application termination. These errors vary in the exact information they carry, but usually contain information such as the file and line number at which the error occurred, an error code, and a description of the error. The information associated with a particular error is almost always consistent and predictable.

Programming languages that rely on a managed runtime tend to allow for more rapid development and deployment of client applications, in particular business productivity software. However, along with their obvious benefits, rapid development and deployment brings with them an increased likelihood of a significant number of application-level errors or bugs. Because these applications operate on top of a managed runtime, the errors manifest themselves as checked runtime errors. Such errors have a variety of causes, ranging from errors in the application logic to unexpected and unanticipated system configurations.

The typical solutions for these errors are rather disparate, ranging from periodic code updates and patches to posted instructions on a software website, newsgroup, or mailing list. Fixes either require explicit action by a user, or rely on a “kitchen sink” methodology—download large updates to fix all known bugs, even those that do not exist for a given system or application configuration. For example, users of an application on a first OS might download a multi-megabyte update, even though much of the update fixes problems found only on another operating system.

Solutions to the problem of detecting and fixing errors before they cause damage abound. One solution provides proactive notification of security holes and errors in the form of messages that appear on a user's computer and prompt the user to take action to fix the problem. Because this solution is proactive rather than reactive, it does not conserve bandwidth or institute just-in-time error fixing. Furthermore, this solution only provides notifications—users are still required to go through with the installation of the upgrade or patch. Finally, this solution is server driven, relying on a constant scan of client machines to identify potential problems and send notifications. A client machine is still susceptible to a bug, even after a fix has been developed, if the machine has not yet been scanned.

Another solution to the problem of detecting and fixing errors includes software that provide its own mechanism for gathering information on client-application crashes, and to allow this information to be reported to the application developers. This tool gives users the option to send crash data to the developer for analysis, and can provide links to information for known problems. This solution, however, does not provide for automatic application of bug fixes and, because it is intended for native software, its ability to detect that a crash is caused by a known problem is limited. Yet, another solution is software that collects and reports errors (again, in native software), but provides no facility for finding and/or applying known fixes. While existing interpreted client-side runtime environments do capture application level errors, they do not use the information for anything beyond informing the user and gracefully allowing for the program to continue (with the error) or to be halted.

Therefore a need exists to overcome the problems discussed above, and particularly for a way to more efficiently recover from application errors.

### SUMMARY OF THE INVENTION

Briefly, in accordance with the present invention, disclosed is a system, method and computer readable medium for performing error recovery for an application. In a preferred embodiment of the present invention, the method on a computer includes capturing an error in the execution of the application, wherein information is associated with the error and generating an identifier for the error based on the information associated with the error. The method further includes generating a message for a third party, the message including the identifier, and sending the message to the third party. If the third party finds a solution to the error based on the identifier, the method further includes receiving the solution from the third party and applying the solution to the application so as to cure the error. If the third party does not find a solution to the error based on the identifier, the method further includes displaying a user message indicating the existence of the error.

In an embodiment of the present invention, the third party is any one of a web site external to a network of the computer, a server on a network external to the network of the computer, a server on the network of the computer or another computer on the network of the computer. In another embodiment of the present invention, the solution is any one of a patch, an upgrade, an update, a data file, a source code file, an executable file and a script file.

Also disclosed is a computer system for performing error recovery for an application. The system includes an error capture module for capturing an error in the execution of the application, wherein information is associated with the error. The system further includes a unique identifier for the error based on the information associated with the error and a message for a third party, the message including the identifier. The system further includes a transmitter for sending the message to the third party and a receiver for receiving the solution from the third party if the third party finds a solution to the error based on the identifier. The system further includes an application modification module for applying the solution to the application so as to cure the error. In an embodiment of the present invention, the system further includes a user interface for displaying a user message indicating the existence of the error when the third party does not find a solution to the error based on the identifier.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1A is a block diagram illustrating the overall system architecture of a conventional computer executing an application.

FIG. 1B is a flowchart depicting the overall operation and control flow of the conventional computer of FIG. 1A, during error recovery.

FIG. 2 is a block diagram illustrating the network architecture of one embodiment of the present invention.

FIG. 3 is a block diagram illustrating the overall system architecture of one embodiment of the present invention.

FIG. 4 is a flowchart depicting the overall operation and control flow of the system of FIG. 3, during error recovery.

FIG. 5 is a flowchart depicting the operation and control flow of the error capture process of one embodiment of the present invention.

FIG. 6 is a flowchart depicting the operation and control flow of the solution retrieval process of one embodiment of the present invention.

FIG. 7 is an illustration of user interface windows used during the error recovery process in one embodiment of the present invention.

FIG. 8 is a block diagram of a computer system useful for implementing the present invention.

### DESCRIPTION OF THE PREFERRED EMBODIMENTS

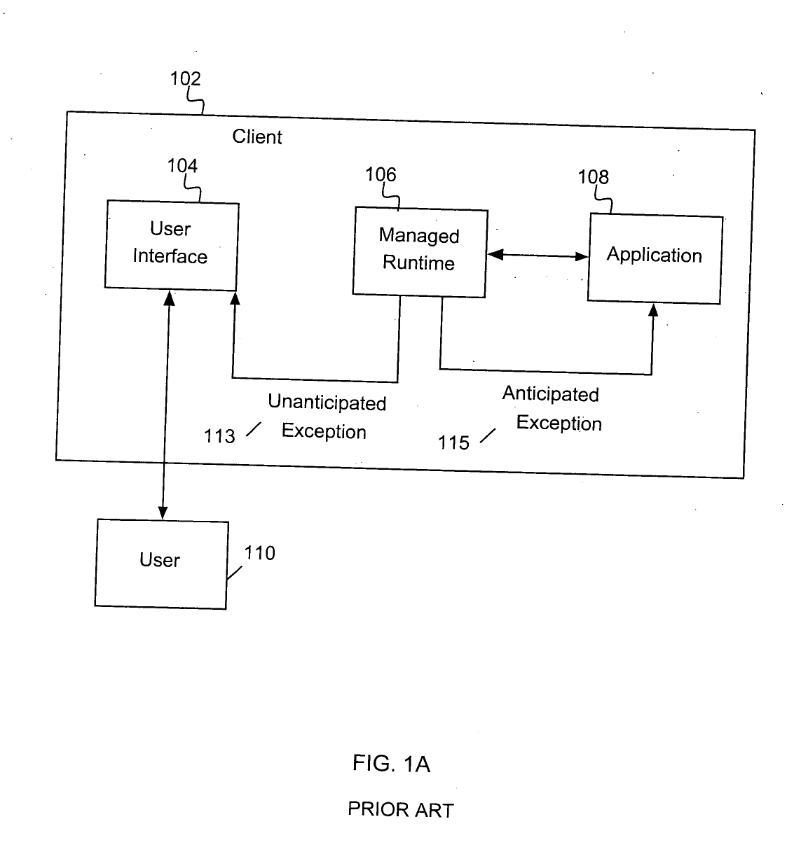

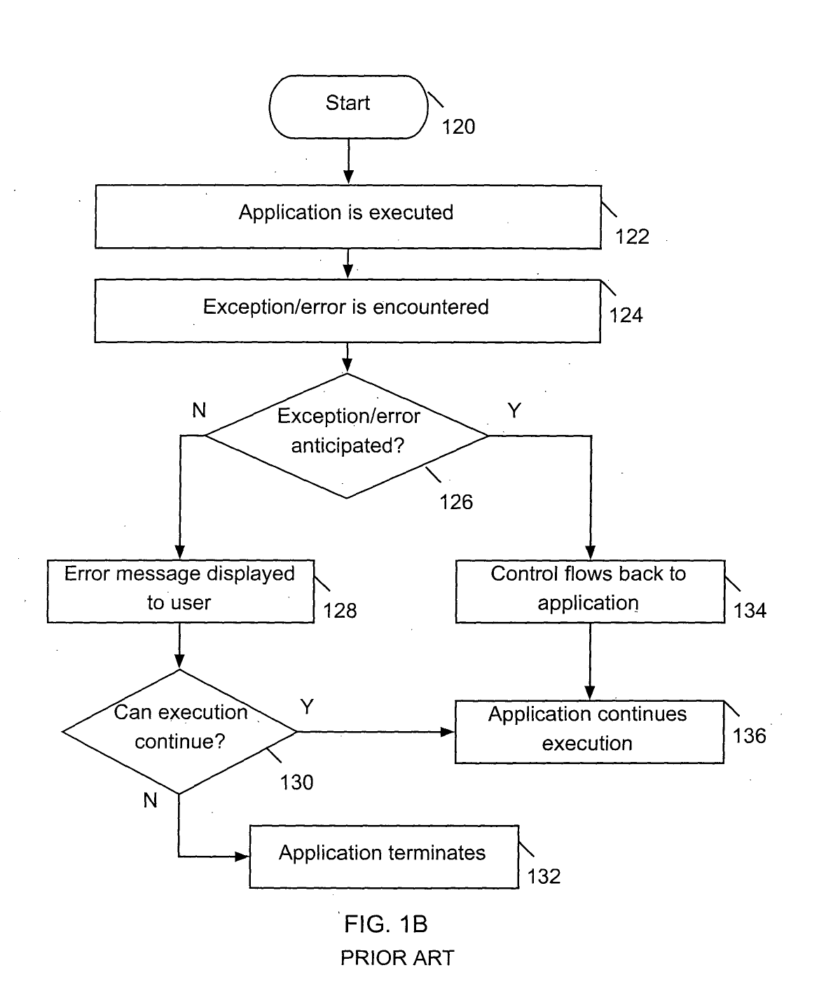

FIG. 1A is a block diagram illustrating the overall system architecture of a conventional computer 102 executing an application 108. FIG. 1A shows a standard application 108, such as a database interface, a spreadsheet program or other financial software, executing via a managed runtime 106 on a client computer 102. FIG. 1A also shows that the managed runtime 106 includes access to a user interface 104, which is a graphical user interface. The user 110 of the computer 102 interacts with the computer 102 via the user interface 104.

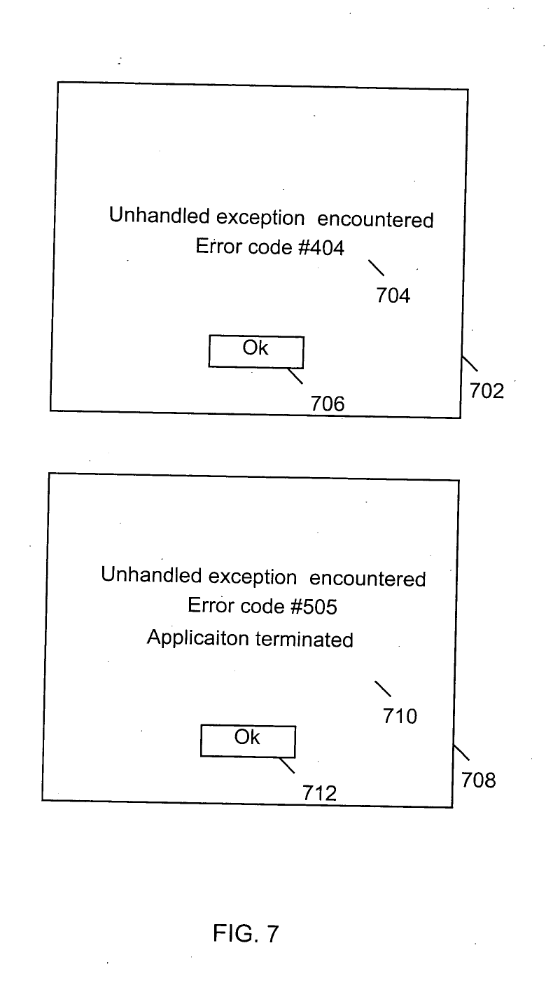

As described above, an anticipated exception 115 is an exception or error that is handled by specific source code in the application 108. In this case, the application 108 captures anticipated exception 115 and handles it as specified in the source code. An unanticipated exception 113 is an exception or error that is not handled by specific source code in the application 108. In this case, the managed runtime 106 handles the unanticipated exception 113 by presenting a message or notice to the user 110 via a user interface 104. Examples of such a user interface 104 are described with reference to FIG. 7 below.

FIG. 1B is a flowchart depicting the overall operation and control flow of the conventional computer of FIG. 1A, during error recovery. The operation and control flow of FIG. 1B provides more detail with regards to the functionality described above with reference to FIG. 1A. The operation and control flow of FIG. 1B begins with step 120 and proceeds directly to step 122.

In step 122, the application 108 is executed on the computer 102 and managed by managed runtime 106. In step 124, an exception or error occurs during the execution of the application 108. The exception is captured by the managed runtime 106. In step 126, the managed runtime 106 determines whether the exception is anticipated or unanticipated. If the exception is anticipated, control flows to step 134. If the exception is unanticipated, control flows to step 128.

As described above, an anticipated exception 115 is handled by specific source code in the application 108. Thus, in step 134, the application 108 captures anticipated exception 115 and handles it as specified in the source code. Consequently, in step 136, the execution of the application 108 continues as specified in the source code. An unanticipated exception 113 is an exception or error that is not handled by specific source code in the application 108 and thus, in step 128, the managed runtime 106 handles the unanticipated exception 113 by presenting a message or notice to the user 110 via a user interface 104. In step 130, the managed runtime 106 determines whether the execution of the application 108 can continue in light of the exception. If execution of the application 108 can continue, control flows to step 136. If execution of the application 108 cannot continue, control flows to step 132. In step 132, the execution of the application 108 terminates.

Overview of the Invention

The present invention, according to a preferred embodiment, overcomes problems with the prior art by providing an efficient and easy-to-implement method for automatic application error recovery using a bug-fix database.

One advantage of the present invention is the automatic nature of the error recovery process. The acquisition and application of a bug fix occurs automatically, without any need for action by the application user. Additionally, because of the presence of a solution database accessible via the Web, a bug fix becomes available as soon as it is developed, whether it fixes a major, minor, common, or uncommon error. This expedites the distribution of the bug fixes and results in a shorter life span for errors and exceptions.

Yet another advantage of the present invention is that the acquisition of a bug fix is reactive, not proactive. That is, a bug fix is only retrieved when the bug it fixes is encountered. This prevents unnecessary downloads of fixes irrelevant to a particular user's system configuration. This results in an application that is free of the hassles of periodic downloads and fixes.

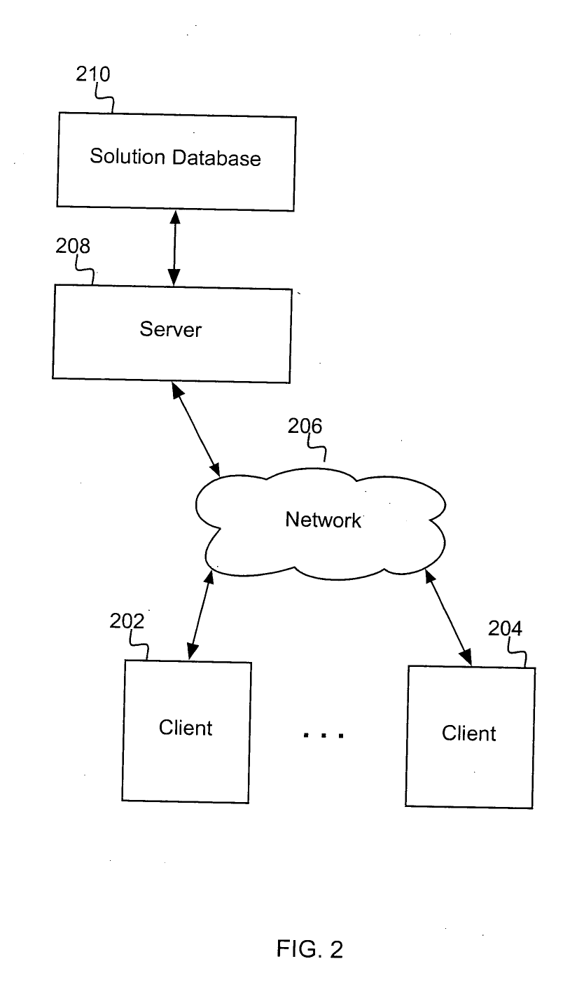

FIG. 2 is a block diagram illustrating the network architecture of one embodiment of the present invention. The exemplary embodiments of the present invention adhere to the system architecture of FIG. 2. FIG. 2 shows client computers 202 and 204, which are typically utilized by a user to navigate web sites or execute applications, connected to a network 206. FIG. 2 also shows server 208 and solution database 210. Server 208 is any commercially available server system that allows client computers 202 through 204 to exist in a client-server relationship, via the network 206, with the server 208.

Solution database 210 is any commercially available database for storage of information, allowing a server such as server 208 to access information via a database management system. Solution database 210 is a repository for storing solutions to errors, bugs or exceptions encountered by an application. Solutions can be any of: a software patch, an upgrade, an update, a data file, a source code file, an executable file or a script file. These solutions are used by client computers to fix errors, bugs or exceptions encountered during execution of an application. Solutions to errors, bugs or exceptions are posted to and registered with the solution database 210 by developers of applications as soon as they become available.

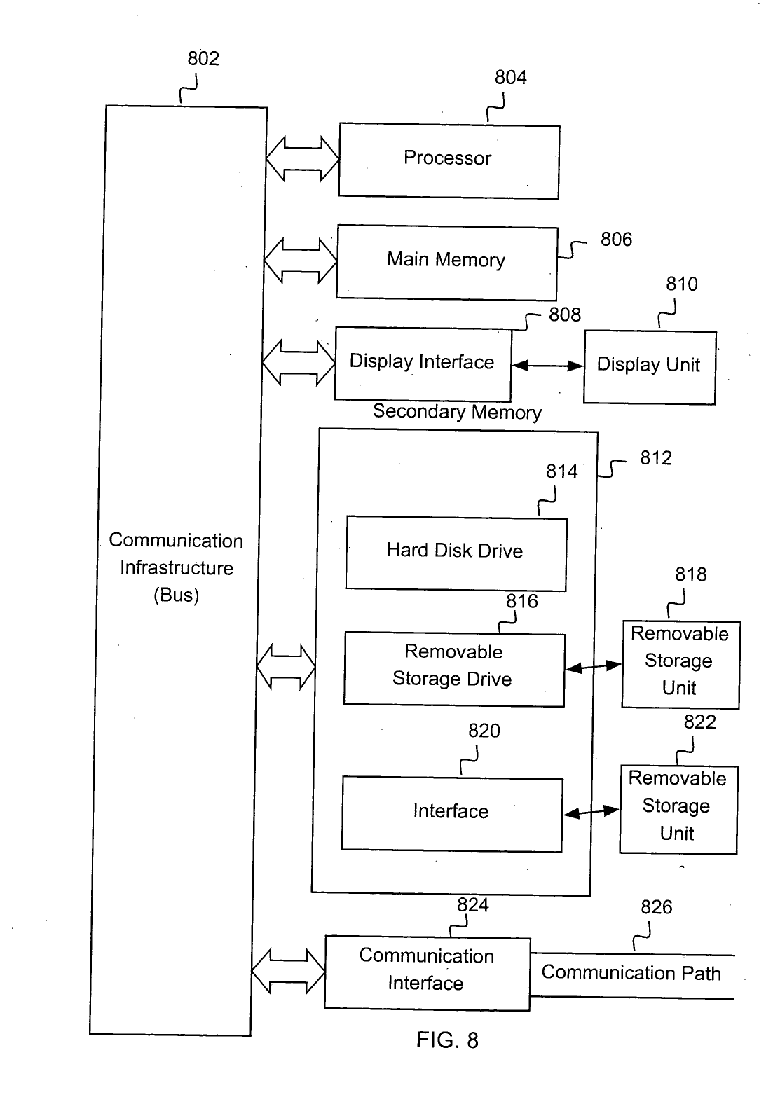

In an embodiment of the present invention, the computer systems of client computers 202 through 204 and server 208 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of server 208 are a server system (e.g., SUN Ultra workstations running the SunOS operating system or IBM RS/6000 workstations and servers running the AIX operating system). The computer systems of client computers 202 through 204 and server 208 are described in greater detail below with reference to FIG. 8.

In an embodiment of the present invention, the network 206 is a circuit switched network, such as the Public Service Telephone Network (PSTN). In another embodiment, the network is a packet switched network. The packet switched network is a wide area network (WAN), such as the global Internet, a private WAN, a local area network (LAN), a telecommunications network or any combination of the above-mentioned networks. In yet another embodiment, the network is a wired network, a wireless network, a broadcast network or a point-to-point network.

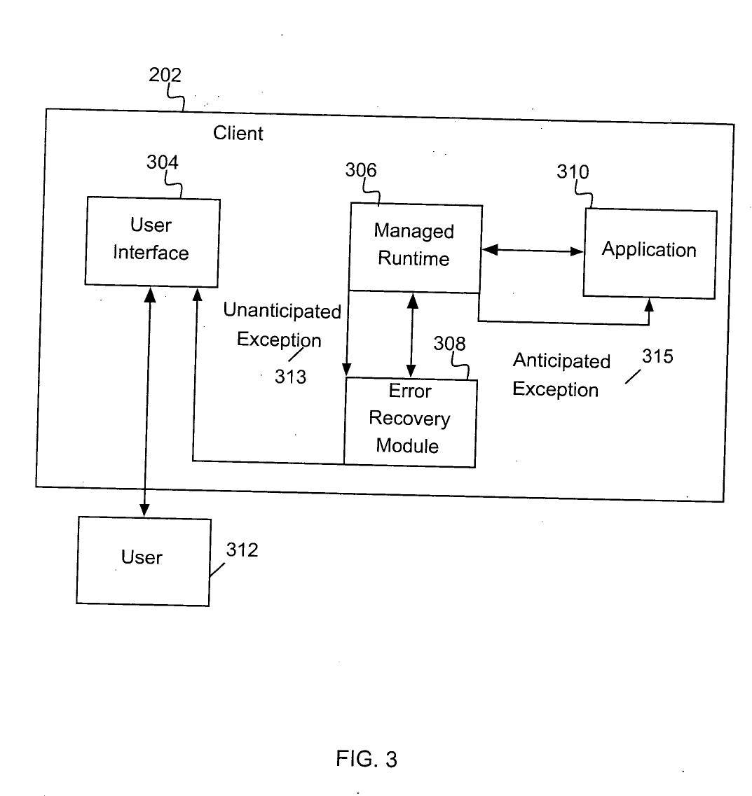

FIG. 3 is a block diagram illustrating the overall system architecture of one embodiment of the present invention. FIG. 3 shows a standard application 310, such as a database interface, a spreadsheet program or other financial software, executing via a managed runtime 306 on a client computer 202. A managed runtime is software that executes to provide resources necessary to allow other software to execute. A managed runtime allows for software that is not compiled into machine-code instructions to execute. Additionally, a managed runtime provides resources to the software executing via the runtime, including memory management and exception infrastructure.

FIG. 3 also shows that the managed runtime 306 includes access to a user interface 304, which is a graphical user interface. The user 312 of the computer 202 interacts with the computer 202 via the user interface 304. FIG. 3 also shows an error recovery module, component or agent 308 for capturing and handling unanticipated exceptions.

As described above, an anticipated exception 315 is an exception or error that is handled by specific source code in the application 108. An anticipated exception is an exception raised either by the application 310 or the managed runtime 306, which is handled by the application 310 without adversely affecting the normal operation of the application 310. For example, in an application executing via a JavaScript runtime, an anticipated exception is one that occurs while executing code in a “try” block and handled via a “catch” block. In the case of an anticipated exception 315, the application 310 captures anticipated exception 315 and handles it as specified in the source code.

An unanticipated exception 313 is an exception or error that is not handled by specific source code in the application 310. An unanticipated exception is an exception raised either by the application 310 or the managed runtime 306, which is not handled by the application 310. An unanticipated exception is an indicator of a problem with the application 310—a bug. In the case of an unanticipated exception 313, the managed runtime 306 recognizes the anticipated exception 315 and refers it to the error recovery module 308. The error recovery module 308 then proceeds to seek and retrieve a solution to the error and apply it to the application 310. If the error recovery module 308 is not able to find an appropriate solution to the error, the error recovery module 308 handles the unanticipated exception 313 by presenting a message or notice to the user 312 via a user interface 304. Examples of such a user interface 304 are described with reference to FIG. 7 below. The functionality of the error recovery module 308 is described in greater detail below.

Error recovery module 308 and managed runtime 306 are depicted as separate modules. However, in one embodiment of the present invention, error recovery module 308 and managed runtime 306 are integrated into one module.

Operation of the Invention

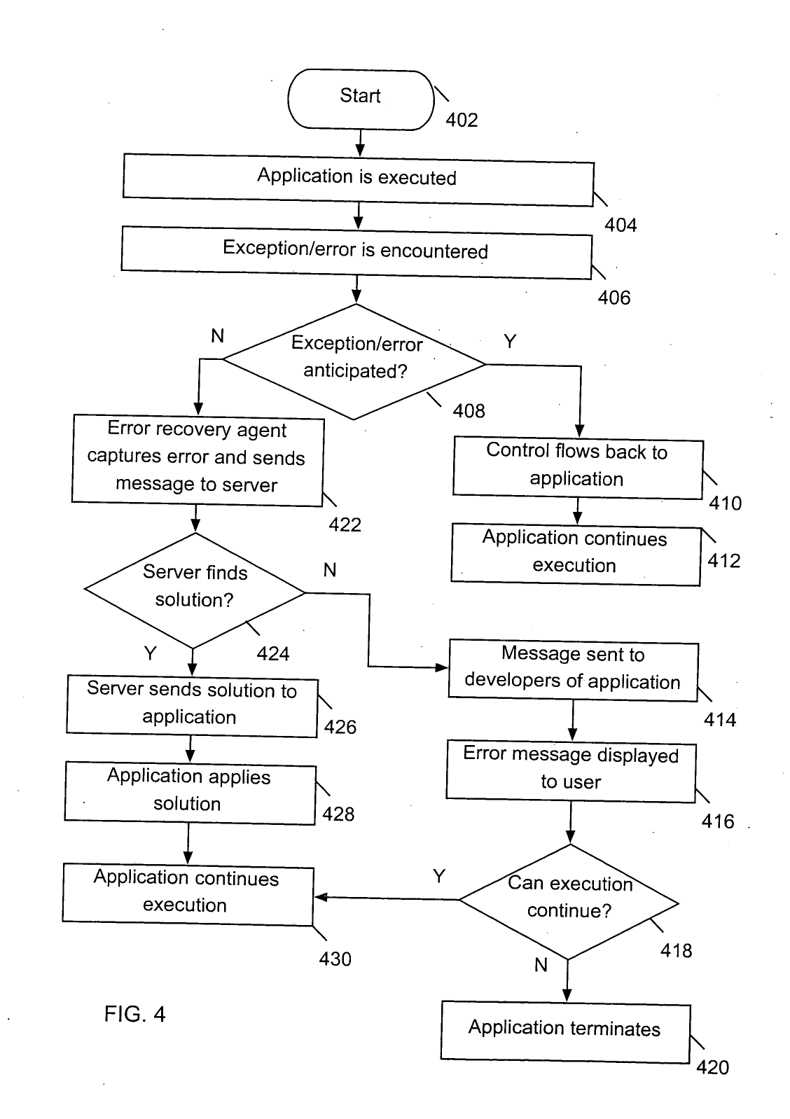

FIG. 4 is a flowchart depicting the overall operation and control flow of the system of FIG. 3, during error recovery. The operation and control flow of FIG. 4 provides more detail with regards to the functionality described above with reference to FIG. 3. The operation and control flow of FIG. 4 begins with step 402 and proceeds directly to step 404.

In step 404, the application 310 is executed on the computer 202 and managed by managed runtime 306. In step 406, an exception or error occurs during the execution of the application 310. The exception is captured by the managed runtime 306. In step 408, the managed runtime 306 determines whether the exception is anticipated or unanticipated. If the exception is anticipated, control flows to step 410. If the exception is unanticipated, control flows to step 422.

As described above, an anticipated exception 315 is handled by specific source code in the application 310. Thus, in step 410, the application 310 captures anticipated exception 315 and handles it as specified in the source code. Consequently, in step 412, the execution of the application 310 continues as specified in the source code.

An unanticipated exception 313 is an exception or error that is not handled by specific source code in the application 310 and thus, in step 422, the managed runtime 306 recognizes the anticipated exception 315 and refers it to the error recovery module 308. The error recovery module 308 then proceeds to seek and retrieve a solution by sending a message to server 208, which checks the solution database 210 for an appropriate solution. Step 422 is described in more detail below. In step 424 it is determined whether the server 208 was able to find an appropriate solution to the error. If the server 208 was able to find an appropriate solution to the error, then control flows to step 426. If the server 208 was not able to find an appropriate solution to the error, then control flows to step 414.

In step 426, the server 208 was able to find an appropriate solution to the error and sends it to the error recovery module 308. In step 428, the error recovery module 308 applies the solution to the application 310. Consequently, in step 430, the execution of the application 310 continues as specified in the source code. In step 414, the server 208 was not able to find an appropriate solution to the error and thus sends a message to the developers of the application 310. The message includes information about the error and the application 310. This information can then be used by the developers to generate an appropriate solution to the error.

In step 416, the managed runtime 306 presents a message or notice to the user 312 via the user interface 304. Examples of such a user interface 304 are described with reference to FIG. 7 below. In step 418, the managed runtime 306 determines whether the execution of the application 310 can continue in light of the exception. If execution of the application 310 can continue, control flows to step 430. If execution of the application 310 cannot continue, control flows to step 420. In step 420, the execution of the application 310 terminates.

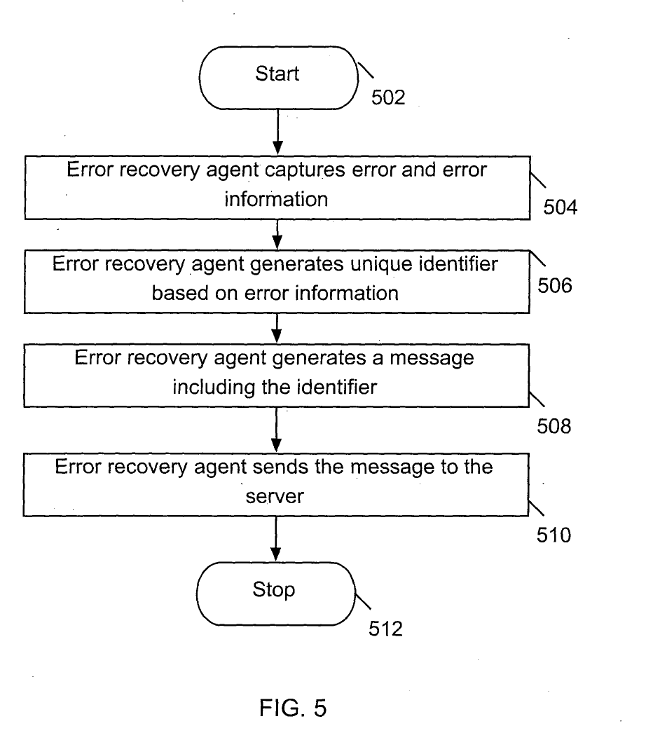

FIG. 5 is a flowchart depicting the operation and control flow of the error capture process of one embodiment of the present invention. The operation and control flow of FIG. 5 provides more detail with regards to step 422 of FIG. 4, depicting the process by which a the error recovery module 308 captures an error and sends a message to the server 208. The operation and control flow of FIG. 5 begins with step 502 and proceeds directly to step 504.

In step 504, the error recovery module 308 captures an error (anticipated or unanticipated) and its corresponding error information. Error information can include any of: the name of the source code file of the application 310, a line number of the source code that caused the error, a description of the error, a code or other identifier associated with the type of the error and a description of the source code that caused the error. In step 506, the error recovery module 308 generates a unique identifier based on the error information. This unique identifier is used by the server 208 to identify a solution corresponding to the error in the solution database 210.

In step 508, the error recovery module 308 generates a message for the server 208, including the unique identifier. The message can be any one of: a TCP/IP message, an HTTP message, an SMTP message and a UDP message. In step 510, the error recovery module 308 sends the message to the server 208 via the network 206. In step 512, the control flow of FIG. 5 stops.

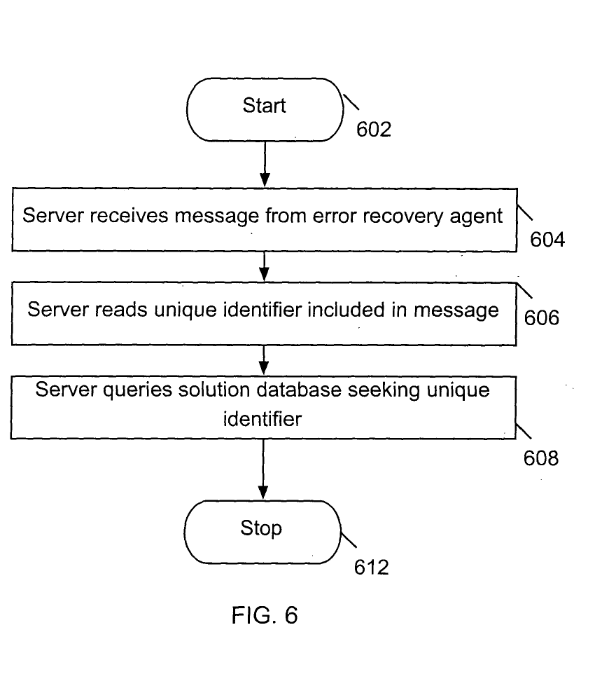

FIG. 6 is a flowchart depicting the operation and control flow of the solution retrieval process of one embodiment of the present invention. The operation and control flow of FIG. 6 provides more detail with regards to step 424 of FIG. 4, depicting the process by which the server 208 seeks and retrieves solutions from the solution database 210. The operation and control flow of FIG. 6 begins with step 602 and proceeds directly to step 704.

In step 604, the server 208 receives the message sent from the error recovery module 308. In step 606, the server 208 reads the unique identifier included in the message. This unique identifier is used by the server 208 to identify a solution corresponding to the error in the solution database 210. In step 608, the server 208 queries the solution database 210 for the solution corresponding to the error identified by the unique identifier. In step 612, the control flow of FIG. 6 stops.

FIG. 7 is an illustration of user interface windows used during the error recovery process in one embodiment of the present invention. User interface window 702 shows an error message 704 indicating that an unanticipated exception has been encountered. Typically, this type of window indicates that a recoverable error has been encountered and the application can continue to execute. An “Ok” button 706 allows a user to proceed through the window 702. User interface window 708 shows another error message 710 indicating that an unanticipated exception has been encountered. Typically, this type of window indicates that a non-recoverable error has been encountered and the application must terminate. An “Ok” button 712 allows a user to proceed through the window 708. The application subsequently terminates.

Exemplary Implementations

The present invention can be realized in hardware, software, or a combination of hardware and software in client computers 202 through 204 of FIG. 2. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product (in client computers 202 through 204), which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 8 is a block diagram of a computer system useful for implementing an embodiment of the present invention. The computer system of FIG. 8 is a more detailed representation of computers 202 through 204 or server 208. The computer system of FIG. 8 includes one or more processors, such as processor 804. The processor 804 is connected to a communication infrastructure 802 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 808 that forwards graphics, text, and other data from the communication infrastructure 802 (or from a frame buffer not shown) for display on the display unit 810. The computer system also includes a main memory 806, preferably random access memory (RAM), and may also include a secondary memory 812. The secondary memory 812 may include, for example, a hard disk drive 814 and/or a removable storage drive 816, representing a floppy disk drive, a magnetic tape drive, an optical disk drive, and more. The removable storage drive 816 reads from and/or writes to a removable storage unit 818 in a manner well known to those having ordinary skill in the art. Removable storage unit 818, represents, for example, a floppy disk, magnetic tape, optical disk, and more. which is read by and written to by removable storage drive 816. As will be appreciated, the removable storage unit 818 includes a computer usable storage medium having stored therein computer software and/or data.

In alternative embodiments, the secondary memory 812 may include other similar means for allowing computer programs or other instructions to be loaded into the computer system. Such means may include, for example, a removable storage unit 822 and an interface 820. Examples of such may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to the computer system.

The computer system may also include a communications interface 824. Communications interface 824 allows software and data to be transferred between the computer system and external devices. Examples of communications interface 824 may include a modem, a network interface (such as an Ethernet card), a communications port, a PCMCIA slot and card, and more. Software and data transferred via communications interface 824 are in the form of signals which may be, for example, electronic, electromagnetic, optical, or other signals capable of being received by communications interface 824. These signals are provided to communications interface 824 via a communications path (i.e., channel) 826. This channel 826 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 806 and secondary memory 812, removable storage drive 816, a hard disk installed in hard disk drive 814, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 806 and/or secondary memory 812. Computer programs may also be received via communications interface 824. Such computer programs, when executed, enable the computer system to perform the features of the present invention as discussed herein. In particular, the computer programs, when executed, enable the processor 804 to perform the features of the computer system. Accordingly, such computer programs represent controllers of the computer system.

### CONCLUSION

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method on a computer for performing error recovery for an application, the method comprising:
capturing an error in the execution of the application, wherein information is associated with the error;
generating an identifier for the error based on the information associated with the error;
generating a message for a third party, the message including the identifier;
sending the message to the third party; and
if the third party finds a solution to the error based on the identifier, receiving the solution from the third party and applying the solution to the application so as to cure the error.

2. The method of claim 1, further comprising the steps of:
if the third party does not find a solution to the error based on the identifier, displaying a user message indicating the existence of the error.

3. The method of claim 1, wherein the application requires a managed runtime to execute.

4. The method of claim 3, wherein the information associated with the error includes at least one of:
a name of a file that includes source code comprising the application;
a line number of the source code that caused the error;
a description of the error;
a code associated with the type of the error; and
a description of the source code that caused the error.

5. The method of claim 3, wherein the identifier comprises a unique identifier.

6. The method of claim 3, wherein the message is any one of:
a TCP/IP message;
an HTTP message;
an SMTP message; and
a UDP message.

7. The method of claim 6, wherein the third party is any one of:
a web site external to a network of the computer;
a server on a network external to the network of the computer;
a server on the network of the computer; and
another computer on the network of the computer.

8. The method of claim 7, wherein the solution is any one of:
a patch;
an upgrade;
an update;
a data file;
a source code file;
an executable file; and
a script file.

9. A computer readable medium comprising computer instructions on a computer for performing error recovery for an application, the computer instructions including instructions for:
capturing an error in the execution of the application, wherein information is associated with the error;
generating an identifier for the error based on the information associated with the error;
generating a message for a third party, the message including the identifier;
sending the message to the third party; and
if the third party finds a solution to the error based on the identifier, receiving the solution from the third party and applying the solution to the application so as to cure the error.

10. The computer readable medium of claim 9, further comprising computer instructions for:
if the third party does not find a solution to the error based on the identifier, displaying a user message indicating the existence of the error.

11. The computer readable medium of claim 9, wherein the application requires a managed runtime to execute.

12. The computer readable medium of claim 11, wherein the information associated with the error includes at least one of:
a name of a file that includes source code comprising the application;
a line number of the source code that caused the error;
a description of the error;
a code associated with the type of the error; and
a description of the source code that caused the error.

13. The computer readable medium of claim 11, wherein the identifier comprises a unique identifier.

14. The computer readable medium of claim 11, wherein the message is any one of:
a TCP/IP message;
an HTTP message;
an SMTP message; and
a UDP message.

15. The computer readable medium of claim 14, wherein the third party is any one of:
a web site external to a network of the computer;
a server on a network external to the network of the computer;
a server on the network of the computer; and
another computer on the network of the computer.

16. The computer readable medium of claim 15, wherein the solution is any one of:
a patch;
an upgrade;
an update;
a data file;
a source code file;
an executable file; and
a script file.

17. A computer system for performing error recovery for an application, comprising:
an error capture module for capturing an error in the execution of the application, wherein information is associated with the error;
a unique identifier for the error based on the information associated with the error;
a message for a third party, the message including the identifier;
a transmitter for sending the message to the third party; and
a receiver for receiving the solution from the third party if the third party finds a solution to the error based on the identifier; and
an application modification module for applying the solution to the application so as to cure the error.

18. The computer system of claim 17, further comprising:
a user interface for displaying a user message indicating the existence of the error when the third party does not find a solution to the error based on the identifier.

19. The computer system of claim 17, wherein the application requires a managed runtime to execute.

20. The computer system of claim 19, wherein the third party is any one of:
a web site external to a network of the computer;
a server on a network external to the network of the computer;
a server on the network of the computer; and
another computer on the network of the computer.
